(19) United States
(12) Patent Application Publication
(10) Pub. No.: US 2002/0143782 A1
(43) Pub. Date: Oct. 3, 2002

(54) Content management system

(75) Inventors: Kevin P. Headings, Pacific Palisades, CA (US); Samuel J. Beckman, Thousand Oaks, CA (US); David Wong, Los Angeles, CA (US); Kenneth Lau, Los Angels, CA (US); Richard T. O'Halloran, Pacific Palisades, CA (US)

Correspondence Address: MARTIN & FERRARO, 14500 AVION PARKWAY, SUITE 300, CHANTILLY, VA, 201511101

(73) Assignee: INTERTAINER, INC.

(21) Appl. No.: 09/921,100

(22) Filed: Jul. 31, 2001

Related U.S. Application Data
(60) Provisional application No. 60/280,691, filed on Mar. 30, 2001.

(51) Int. Cl. G06F 7/00

(52) U.S. Cl. 707/100

(57) ABSTRACT

The present invention is directed to systems and methods for the preparing, programming, and publishing media assets for storage on a memory medium as a collection of media content. In a preferred embodiment, media assets are combined with metadata to form media content data structures suitable for subsequent distribution and storage at one or more memory storage locations where it may be accessible for viewing over a network by consumers during a selected interval of time. Additional data structures containing different media content are prepared and readied for offering to the consumers after the selected interval of time has elapsed. The media content may be formed and distributed based on viewing preferences or habits of the consumers and the availability of selected media assets during the selected interval of time.

### RELATED APPLICATION

This application claims the benefit of U.S. Provisional Application No. 60/280,691, filed Mar. 30, 2001, incorporated by reference herein.

### BACKGROUND

The digitization of media content (e.g., movies, music videos, educational content, television shows, games, live events, advertising, literary works, audio programs, and other media assets) is becoming more and more common with the advent of technology that allows content suppliers to derive revenues from these assets in a digital marketplace. Content suppliers may include entities that own the content, have rights to the content, or are otherwise suppliers of the media assets. For purposes herein, media assets form a subset of media content. There is a cost for entry into the digital space that requires infrastructure and processes to effectively manage and distribute various forms of media assets, particularly over high bandwidth channels of communication (e.g., digital cable, Internet protocol, and satellite). Content suppliers are not traditionally equipped to handle these requirements and would benefit from a system that minimizes the barrier to entry into the digital marketplace.

Users of content also have barriers in the digital marketplace. For purposes hereof, a “content user” is any person or entity that sells or otherwise exploits media assets. A content user may be, for example, the content supplier, a digital services platform operator, an online site builder, an educational institution, or a retailer. One issue facing content users is that consumers want to enter online “malls” or stores that allow them to browse and purchase a wide variety of content choices. This presents unique challenges to content users wishing to develop and sell compelling digital services to these consumers. For example, consumers are used to contemporary brick and mortar stores that allow them to browse and purchase from a fully “aggregated” content offering (e.g., a record store). This offering is not content supplier specific; rather, stores tend to group content by genres and aisles that make sense to the consumer. In short, a consumer looking for music content does not browse the “Brand X” aisle looking for “Brand X” content offerings; instead they browse “New Releases” and “Rock.” Consumers expect an aggregated content set. For purposes hereof, “consumers” are people who view, listen, or interact with the content (e.g., people watching television).

While stores prefer to offer music to consumers based on genre, content suppliers still wish to have some control over the presentation of their content to the consumer. Content suppliers often require a measure of control over the timing and manner of distribution of their content to a consumer. For example, a content supplier may wish to release a movie for distribution only after a sufficient amount of time has elapsed since the movie's theater run, or a particular season in line with the content of the movie (e.g., distributing scary movies during the Halloween season, or Christmas movies during the Christmas season). The content supplier may further wish to specify, for example, an amount charged per viewing, the mode of delivery to a consumer, and a geographic region for release. In addition to placing these and other restrictions or limitations on the distribution of media content, content suppliers usually expect the payment of royalties.

Many content suppliers and content users are not skilled in the art of digitizing and managing content for diverse digital service platforms (e.g., cable set-top box, digital subscriber line (DSL), and satellite platforms). Traditional brick and mortar establishments typically do not sell media content in digital form and have not dealt with issues such as encoding, encryption and license tracking. Moreover, in the digital space, the aggregation of compelling and diverse media content often requires licenses from numerous content suppliers who impose restrictions on the use of their media content. The ability to individually manage each media asset from each content supplier in accordance with their varying restrictions and requirements can also be a daunting task for many content users. In view of the foregoing, there is a need for a system that manages media content from multiple content suppliers having unique requirements with respect to the storage, preparation, reporting, and distribution of their media assets.

### SUMMARY OF THE INVENTION

The present invention is directed to systems and methods for managing the preparation, programming, and publication of media assets. Media content may include, for example, media assets, metadata (i.e., descriptive information regarding a particular asset, for example, the information usually found on a video cassette jacket), and specified web publishing (Flash™ animation and e-commerce opportunities). Specified web publishing includes files not generally included in metadata or assets. Media content is preferably created or developed in a development phase and then migrated to a staging phase where quality assurance is performed. Upon passing quality assurance, media content is preferably migrated to a field phase to form a collection of content that is offered to consumers during a designated period via streaming, digital downloads, or other methods of digital delivery.

In a preferred embodiment, the present invention encompasses at least three main functions: content preparation, content programming, and content publishing. Content preparation preferably occurs in the development phase and provides a naming convention to media assets (e.g., feature movies, music videos, literary works, and advertisements) by associating media assets with metadata. Content preparation also preferably prepares the media assets for delivery to particular groups of consumers (e.g., encoding media assets according to end viewer bit rate requirements), and combines media assets to form items or groupings (e.g., combining a feature movie with a movie trailer, branding art, and advertisements). As used herein, an “item” includes one or more media assets and related metadata and/or other data.

Content programming, which may occur in either or both the development and staging phases, selects media content for distribution to particular groups of consumers based on, for example, geographical location, bit rate service, service provider, and contract terms or business rules. “Business rules” define the parameters for using a particular media asset. For example, business rules for a first-run movie may require the content user to sell the movie at a set price (e.g., $3.95), or a particular price range, or to encrypt the movie, or to digitize the movie at a specific bit rate, or to deliver the movie via streaming or digital downloading over a cable network, rather than a DSL network.

Content programming preferably aggregates the selected media content for inclusion into a “package” (a delivery and storage data structure capable of delivering one or more items at a time) to form a part of a publishing group database (“PGD”). The PGD is a collection of media content that is offered to a designated group of consumers. Older items in the PGD are periodically replaced by newer items in the PGD in order to provide consumers with fresh media content and to exchange media content based upon contractual restrictions associated with the media content.

Content publishing preferably prevents the exhibition of incomplete or low quality media content by preferably subjugating items to one or more quality assurance checks. Once an item has passed quality assurance, content publishing migrates the item in the package to the field phase to join other items being offered to consumers in the PGD.

In another preferred embodiment, content programming aggregates the selected media content into a rollout. A “rollout” is a collection of content for exhibition preferably during a designated period of time to a designated group of consumers. Older rollouts are periodically replaced by newer rollouts. Content publication locks the rollout configuration into its final form to halt further content changes for a selected period of time and to meet distribution deadlines. In addition, content publishing applies business rules, as provided by content suppliers and content users.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is a representational diagram of a content management system consistent with a preferred embodiment of the present invention;

FIG. 2 is a logic diagram of a preferred method for developing an item in the development phase in accordance with the present invention;

FIG. 3 is a logic diagram of a preferred method for checking the quality of an item in the staging phase in accordance with the present invention;

FIG. 4a is a logic diagram of a preferred method for performing the item creation step of FIG. 2;

FIG. 4b is a preferred embodiment for a graphical user interface for use in performing the item creation step of FIG. 2;

FIG. 5 is a logic diagram of a preferred method for performing the procedure for encoding assets;

FIG. 6 is a logic diagram of a preferred method for performing the asset association step of FIG. 2;

FIG. 7 is a logic diagram of an initial quality assurance procedure of FIG. 3;

FIG. 8 is a logic diagram of a preferred method for programming content in accordance with the present invention;

FIG. 9 is a logic diagram of a preferred method for performing the master plan rollout creation step of FIG. 8;

FIG. 10 is a logic diagram of a preferred method for performing the production rollout file creation step of FIG. 8; and

FIG. 11 is a logic diagram of a preferred method for performing the production rollout creation step of FIG. 8.

### DESCRIPTION OF THE PREFERRED EMBODIMENTS

Reference will now be made in detail to the present preferred embodiments (exemplary embodiments) of the invention, examples of which are illustrated in the accompanying drawings. Wherever possible, the same reference numbers will be used throughout the drawings to refer to the same or like parts.

The present invention is directed to systems and methods that automate content management workflow, from receipt of media assets and related data and/or specified web publishing, through encoding, quality control, data entry and distribution of the media assets as items in a package for storage on a publishing group database (PGD) for offering to content users and consumers. Media assets may include, for example, movies, music videos, educational content, television shows, games, live events, and advertising. Related data may include, for example, metadata (e.g., artist and director information, authors, copyright information, abstracts, duration, title, and content contract restrictions).

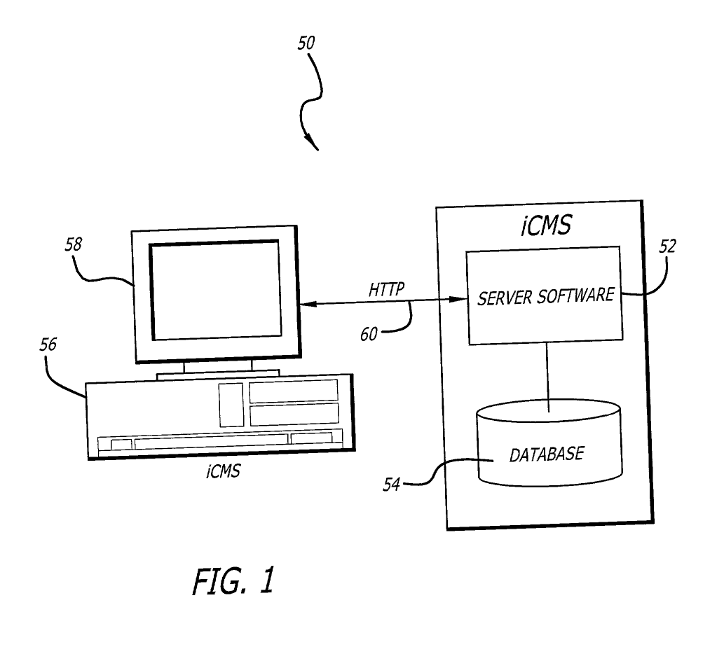

FIG. 1 illustrates a content management system 50 consistent with a preferred embodiment of the present invention. Preferably, content management system 50 is a software-based system that includes server software 52, a database 54 (e.g., a relational database management system (RDBMS)), a computer 56, and client software 58, which enables the content management functions of the present invention. Computer 56 may communicate with server software 52 and database 54 over a local or wide area network (e.g., the Internet) through communications channel 60 (e.g., HTTP). Communications channel 60 may be hard-wired or wireless (e.g., cable, satellite, DSL, and wireless land-based phone systems. Client software 58 generates a graphical user interface to allow an operator to enter, modify, view or retrieve data stored in database 54 and create packages or rollouts for distribution to content users and consumers. Content management system 50 may operate as a stand-alone system or as part of a platform that offers multiple media-related services. Examples of preferred platforms operable with content management system 50 are taught in U.S. Application Serial No. 60/280,653, titled “Digital Entertainment Service Platform,” and U.S. Application Serial No. (to be assigned), titled “Systems and Methods for Delivering Media Content,” filed Jul. 31, 2001, which claims priority to U.S. Application Serial No. 60/255,725, the disclosures of which are hereby incorporated by reference herein.

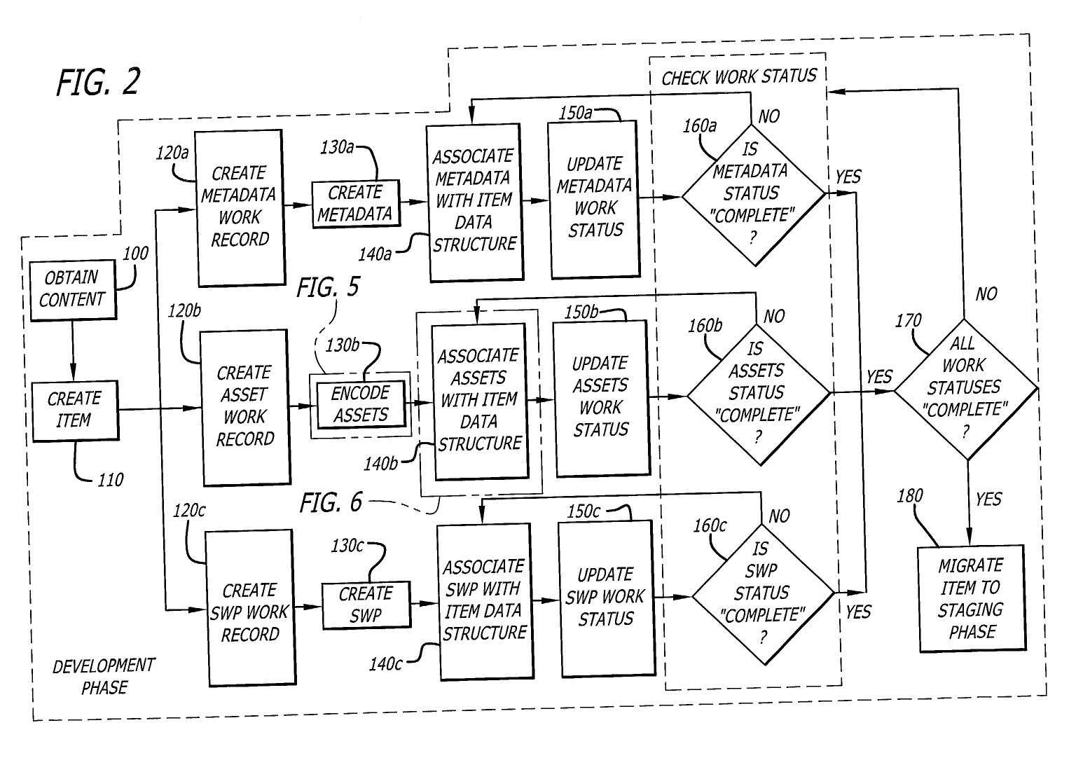

In a preferred embodiment, the present invention is preferably adapted to perform three main functions: prepare, program, and publish content. As shown in FIG. 2, in the preparation of content, content is obtained in step 100. Obtaining content step 100 may be accomplished, for example, through contracts, licenses, and other agreements with content suppliers to use their media assets. A content supplier may provide media assets on contemporary and standard media sources, for example, Digital Betacam, digital linear tape (DLT), or VHS, or electronically using file transfer protocol methods or other known ways of delivering digital data. Content suppliers may also provide metadata or other data related to the media assets (e.g., movie trailers and publicity photos) as well as business rules for one or more media assets to the content user (e.g., platform operator). The business rules may be provided to the content user in writing or through an interface (e.g., website portal). For example, the content user may construct an interface for content suppliers with defined fields for entering information regarding the treatment or use of each media asset or group of media assets. As used herein, the term “treatment” refers to at least one parameter relating to the use of the media asset, such as, for example, the distribution and/or accessibility of a media asset or group of media assets. By way of example only and not limitation, treatment parameters related to the distribution of one or more media assets may include any one of or a combination of a type of media being deposited (e.g., first-run movie), a service platform for distributing the media asset (e.g., cable and DSL platform), a level of encryption (e.g., low, medium or high), specific retailers for selling the media asset, a geographic location, a bit rate, and a method of delivery (e.g., streaming or digital downloads). As used herein, the term “accessibility” relates to the ability of a consumer to obtain media content. By way of example only and not limitation, treatment parameters related to the accessibility of one or more media assets may include any one of or a combination of a contract window where the media asset(s) are available for offering to one or more consumers, a price or price range, and parental controls.

The content user may create other business rules governing the distribution, marketing, or other use of the media asset. For example, the platform operator may impose business rules on whether a particular media asset is enhanced for interactivity or combined with an electronic commerce fulfillment system (e.g., to sell merchandise related to the media asset). Using associated metadata and business rules, content management system 50 manages the preparation, programming, and distribution of media assets.

In step 110 of FIG. 2, content management system 50 creates an “item,” which preferably includes one or more media assets and related metadata and/or business rules. For example, an item may represent a data structure that includes at least one or more media assets, the title of each media asset (e.g., the movie title “Gladiator”) and other metadata, along with its contracted viewing window and other associated business rules.

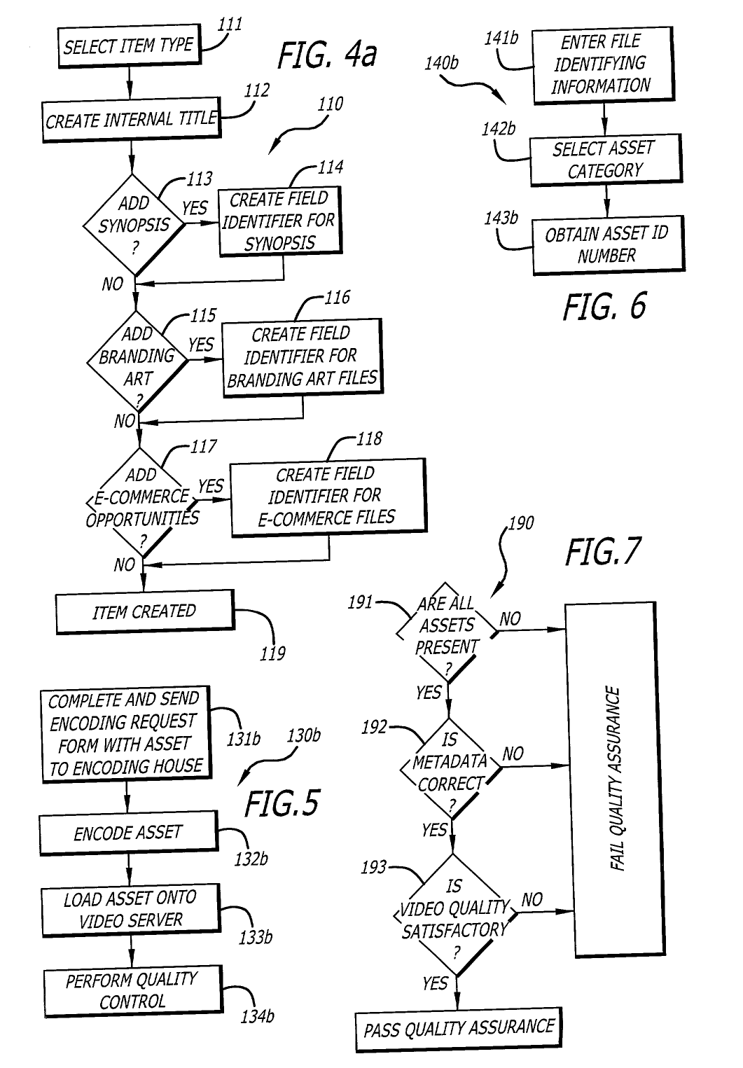

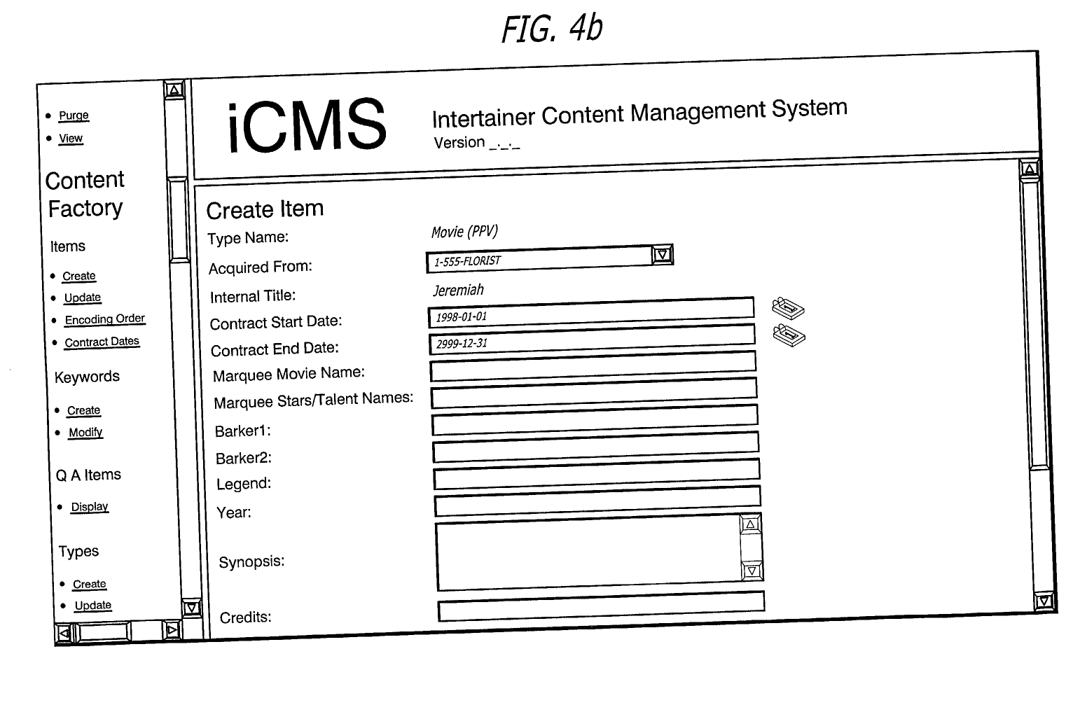

As shown in FIG. 4a, creating an item data structure preferably involves selecting an item type in step 111, and then creating a unique identifier or internal title used to track the item data structure for further use in step 112. Each item may be categorized by item type or category. Examples of item types include movies, adult movies, television programs, books, music, music specials, and radio. Each data structure includes a plurality of fields. A number of the fields are preferably defined at least in part by the item type of the data structure. Each defined field may correspond to any one of a plurality of different categories of media content (e.g., media assets, metadata, and specified web publishing). Each defined field may further correspond to any one of a plurality of sub-categories depending upon the base category. The quantity and variety of sub-categories may vary depending upon the item type. For example, for a movie item type, a media asset category may include any one of a preview video, a feature video, a browser thumbnail (i.e., a small image on a viewer's screen of a promotional piece for the item, such as a movie poster) and branding art. If the item type were, for example, music, then preferred media asset categories may include a preview video, tracks, an album cover, a browser thumbnail, and branding art. Each item data structure may have more than one field assigned to the same media content category, but different sub-categories. For example, a movie item type may have two media asset fields, one corresponding to a feature video, the other corresponding to a preview video. It will be appreciated that one or more of the fields may be adapted to correspond to more than one sub-category if desired.

Exemplary metadata sub-categories common to all item types may include the type name, the name of the content supplier, the internal title of the item, a synopsis of the item, the price, the run time, and any parental controls. Examples of metadata subcategories specific to a particular item type, such as a movie, may include names of actors, a movie rating, and movie credits. Exemplary sub-categories of specified web publishing include Flash™ animation and e-commerce opportunities.

Business rules are also preferably associated with the item data structure and may exist in combination with metadata, specified web publishing, or under its own category, or any combination thereof depending upon the particular business rule. Examples of business rules include the contract start/end date, the price of the content, the level of encryption, and the distribution platforms for the content (e.g., Internet, satellite, cable, DSL, land-based wireless systems). Contract start and end dates are those dates set by contract with the content suppliers that define the period that the content may be shown. Price is the amount that will be paid for a pay-per-view content. Parental controls are optional and may be used to restrict viewing for mature content.

FIG. 4b illustrates an example of a graphical user interface of content management system 50 for creating an item in accordance with a preferred embodiment of the present invention. In use, the system operator may input information such as item type name, content supplier, item title, contract start and end dates, and a synopsis, among others.

As shown in FIG. 4a, steps 113-118 illustrate a decision-making process involving the addition of fields associated with a metadata sub-category, a media asset sub-category, and a specified web publishing sub-category to an item data structure for a movie item type. In step 113, an option is provided whether to add a synopsis file or continue without adding a synopsis file. The synopsis may be that of a related media asset to be associated with the item data structure. If it is decided to add a synopsis file, then in step 114, a system operator (e.g., an operator of content management system 50) creates an item synopsis field identifier to facilitate the association of a synopsis file with the item data structure. Other metadata field identifiers may be created as desired. For example, for music items, field identifiers for sound tracks may be created or modified. As another example, for ad items, a field identifier for demographic metadata may be entered in step 114. In the preferred embodiment in step 115, it is decided whether to associate branding art with the item data structure. Branding art is art that identifies the origin of the media asset, for example, logos or trademarks associated with a particular movie studio. In step 116, the system operator creates a branding art file field identifier for facilitating the association of selected branding art with the item data structure.

In step 117, e-commerce opportunities may be associated with the item data structure. If e-commerce opportunities are to be associated, then in step 118 the system operator will create the one or more field identifiers necessary to associate e-commerce information with the item data structure. For example, e-commerce information might include a shipping unit, a store identifier, a title, one or more descriptions that include pricing information, and/or a unique e-commerce identifier. Shipping unit indicates the number of objects purchased in a given package. The store identifier identifies the vendor that is supplying the product. The e-commerce identifier is used to associate particular e-commerce information with an item. After creating the desired field identifier, in step 119 the item data structure is completed and the item generated. It will be appreciated by those skilled in the art that other field identifiers for metadata, media assets and specified web publishing may be created. It should be apparent from this and any other methods described that various steps may be added, interchanged, or deleted altogether. For example, a field identifier for the association of e-commerce information with the item data structure may be created prior to the field identifier for the association of the branding art with the item data structure. Alternatively, if no specified web publishing is planned for an item, then steps 117 and 118 may be omitted.

Interactivity may also be associated with an item data structure to permit consumers to interact with the content. If interactivity is to be associated, the system operator may, for example, create a field identifier for the association of a URL with the item data structure that is linked to a “floating bug” to be presented over the content delivered to the consumer. An example of a preferred system and method for creating interactive content is taught in U.S. Application Serial No. (to be assigned), titled “A System and Method for Interactive Video Content Programming,” filed Jul. 31, 2001, which claims priority to U.S. Application Serial No. 60/255,541, the disclosures of which are hereby incorporated by reference herein.

In reference to FIG. 2, after the item data structure has been created, the components of the item data structure (e.g., metadata, media assets, specified web publishing) are preferably developed by work groups charged with developing and completing each component of the item. For example, one work group may be responsible for developing the metadata for the item while another work group is responsible for developing assets for the item. The assignment of work groups to develop the components of the item increases the efficiency of the overall development process and provides and easy method of correcting item components should one or more components need to be re-developed.

As shown in FIG. 2, work records for metadata, assets and specified web publishing can be created steps 120a-120c. The work records identify, for example, the individuals responsible for the work product within a work group, project deadlines, and other information related to the work product. In step 130a, metadata is created for the item. If the metadata already exists, then step 130a may be omitted. Alternatively, any existing metadata may be modified as desired.

In FIGS. 2 and 5, step 130b, media assets are encoded to permit distribution over a network. Encoding may include, for example, adapting a media asset to a particular bit rate (e.g., 500 kbps). The encoding process illustrated in FIG. 5 involves completing and sending an encoding request form with a media asset to an encoding facility in step 131b. This encoding request preferably describes all the media assets required for a particular asset type along with the assets file name. Thereafter, the media asset is encoded in step 132b. In step 133b, the media asset is loaded onto a large storage device having a sufficient memory capacity (e.g., a video server). Thereafter, in step 134b, a quality control procedure is initiated. Quality control helps ensure that asset encoding is of a satisfactory quality. At the end of the quality control process, the media asset is tagged as “complete.” Preferably, only items with completed media assets are run through the quality assurance procedure (described below).

In step 130c, specified web publishing is created. As with the metadata in step 130a, this step may be omitted for specified web publishing already in existence, or modified as desired.

In steps 140a-140c, metadata, assets, and specified web publishing are associated with the item data structure. This is preferably accomplished by creating a file with a unique identifier and associating the file with the item data structure. For example, with media assets in step 140b of FIGS. 2 and 6 an asset file is created and associated with the item data structure. To create an asset file, the system operator initially enters file-identifying information in step 141b of FIG. 6. Such file identifying information may include, for example, an asset description, an asset classification, an art suffix, and a file extension. Next, in step 142b, the system operator selects an asset category. The asset category may include, for example, an ad video, a feature movie, or TV branding art amongst others. In step 143b, the asset file name is created and an asset identification number is obtained. Media assets may be associated with items by using an assets menu and selecting an item by using, for example, a pull-down menu with a listing of item identification numbers.

When associating e-commerce opportunities with the item data structure, a link may be established between one or more advertisements and one or more entities associated with the subject matter of the advertisement(s).

In steps 150a-150c of FIG. 2, the work status of each item component is updated. The components that have all their sub-components developed and associated with the item data structure have their status updated to “complete.” For example, if the media assets component is to include the sub-components of a preview, branding art and a feature movie and all the sub-components have been associated with the targeted item data structure via, for example, an item data structure identifier, then the media asset component status is updated from “incomplete” to “complete.” In steps 160a-160b, the work status of each component is checked. If the work status is “incomplete,” then work on the component continues within the work group until a “complete” status is achieved. In step 170, it is determined if all components have a “complete” status. If all statuses are “complete,” the item is migrated onto the staging phase in step 180 for quality assurance. If all statuses are not “complete,” steps 160a-160c are repeated until all components are “complete.”

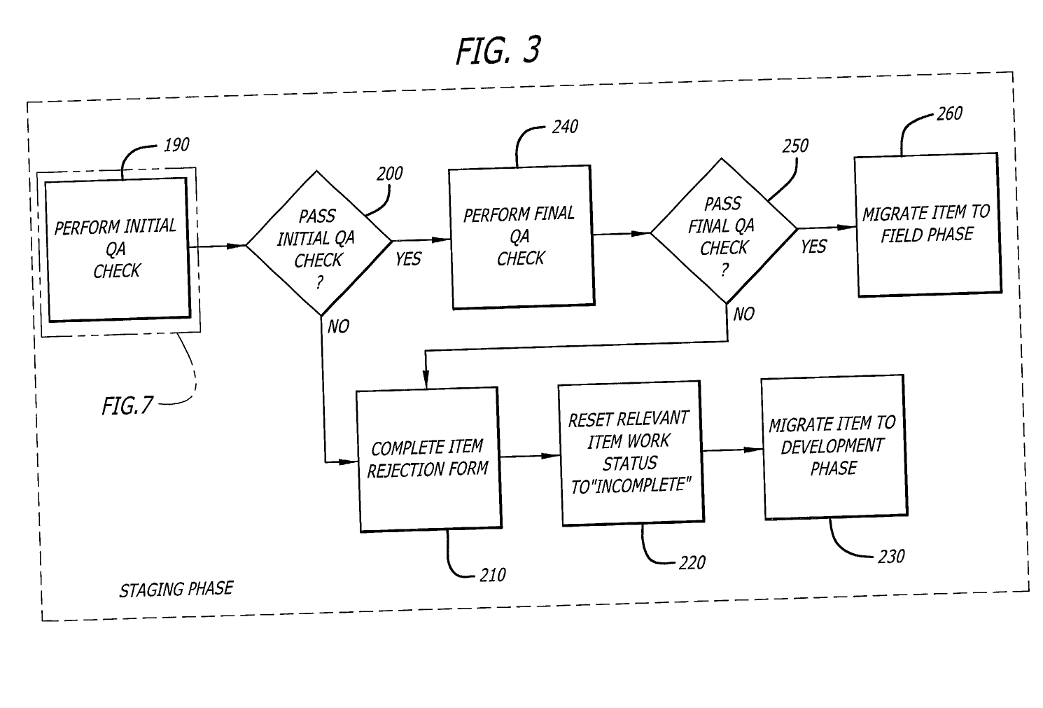

As shown in FIGS. 3 and 7, while in the staging phase, content management system 50 implements an initial quality assurance procedure 190. The quality assurance procedure involves viewing the item (e.g., watching an interactive television program) to verify completion of the item. Upon satisfactory completion of quality assurance procedure 190, content management system 50 may include the item in the package. Alternatively, during the creation and/or management of a media asset and prior to going through quality assurance, the item may be designated as “inactive.” An “inactive” item will not be published. To include the item in the package for publication, the status can be changed from “inactive” to “active.” As explained above, the “package” is a delivery data structure capable of delivering one or more items to a destination (e.g., the field phase). Packages may be created by associating the unique identifier of selected items with the package data structure.

Once delivered to the destination, the package preferably forms a part of the publishing group database (PGD) and functions to store the item(s) until such time a command is received to delete, edit, or otherwise modify the package or any of the items therein. Packages may be programmed with begin dates and end dates so that the items associated with a particular package preferably will be offered to consumers for only a selected interval of time. Packages also may be utilized to deliver item remove commands to the PGD. For example, a package being offered to consumers on a PGD may be copied in the development phase and one or more items deleted from the package. The revised package may then be delivered to the PGD to replace the package currently being offered.

Preferably, the item will be placed in the package prior to undergoing quality assurance. Placing the item in a package prior to quality assurance makes the quality assurance process more efficient if more than one item is to be migrated to the field phase at once. For example, items having the same target date and destination may be placed in the same package and go through the quality assurance process together.

FIG. 7 shows a preferred quality assurance procedure. As shown in step 191, the system operator determines whether all of the media assets are present. If not, then quality assurance is not passed. In step 192, it is determined whether the metadata is correct. If the metadata is incomplete, then the metadata does not pass quality assurance. In step 193, it is determined whether the content (e.g., video) is of satisfactory quality. If it is not, then the content does not pass quality assurance. For items not passing quality assurance in step 200, an item rejection form is completed in step 210. In step 220, the relevant item work status is changed to “incomplete.” Thereafter, in step 230 the item is migrated to the development phase. The preferred components of the item (e.g., metadata, media assets or specified web publishing) that have a deficiency are automatically returned to the development group responsible for the development of the component in order to correct the deficiency. Once any deficiencies have been corrected, the item is migrated again from the development phase to the staging phase. If all media assets are present, the metadata correct, and the video quality satisfactory, then the item passes quality assurance.

In step 240 of FIG. 3, a final quality assurance step may be added which involves viewing the items to determine the performance of the items as delivered over a particular network (e.g., cable network) to the consumer. The network may have certain limitations (e.g., latency) that may affect the quality of the media assets upon reaching the consumer. These network limitations may be addressed and resolved on a case-by-case basis. The final quality assurance procedure preferably ensures that consumers are provided the highest quality of content. If final quality assurance is passed in step 250, then the item is migrated as part of a package onto the field phase over a communications network in step 260 via software such as Repliweb®. If final quality assurance is not passed in step 250, steps 210-230 are performed as mentioned above.

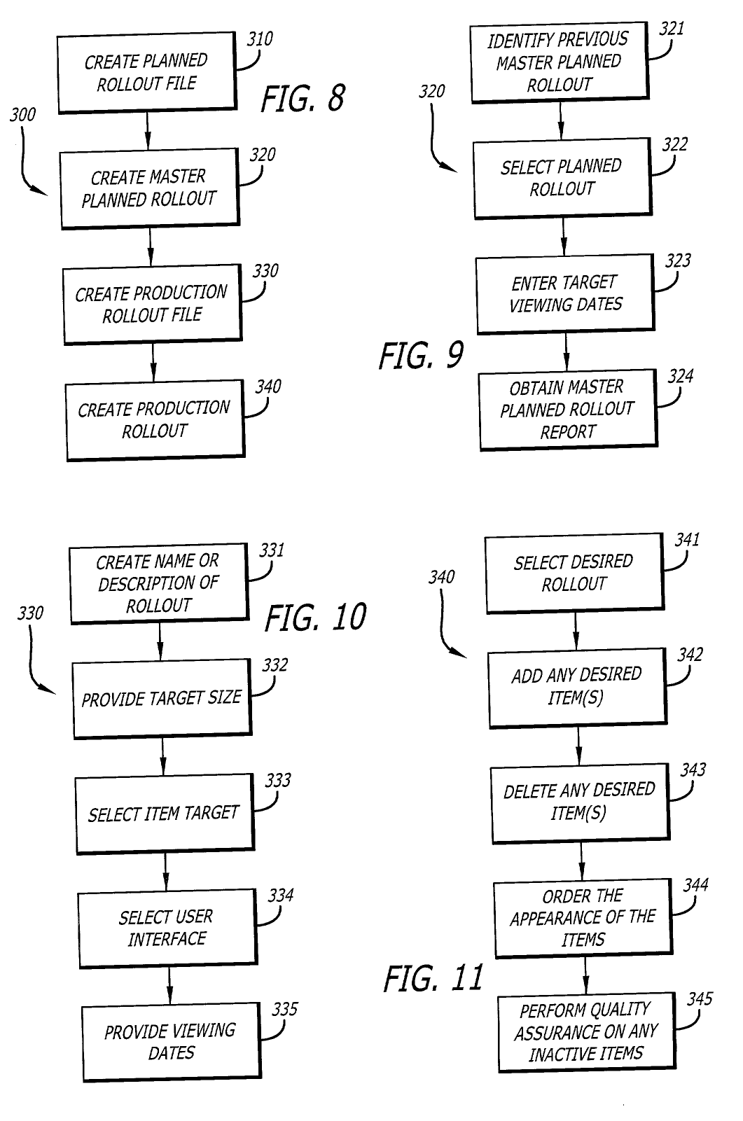

FIGS. 8-11 show another preferred embodiment of the present invention. Instead of updating a PGD with packages, the entire PGD may be replaced with a rollout. In forming a rollout, media assets are combined with metadata to form collections of media content. Each rollout is then stored as a data structure for subsequent distribution to one or more storage locations where it may be accessible for viewing over a network by a plurality of consumers during a selected interval of time. For example, one rollout might be available between a period between March 5 and March 18. A subsequent rollout could be readied and available for a period between March 19-April 2. Each rollout may retain a portion of the content from the previous rollout while changing a portion to add or delete content. Additional data structures containing different rollouts may be prepared and readied for offering to the consumers after the selected interval of time has elapsed.

Rollouts may be configured for a selected group of consumers associated with a storage location. For example, the content of the rollout may be selected based on the demographics and/or viewing habits of consumers.

As illustrated in FIG. 8, in step 300, content is programmed and built into a rollout data structure. In particular, FIG. 8 identifies planned rollouts for future planning activities (also referred to herein as “availability planning”). Availability planning involves creating a list of new content to be added to the rollout and old content to be removed from the rollout. In step 310, a planned rollout file is created in content management system 50. The planned rollout file may be created by associating a name or description with the file. A planned rollout may be created many months in advance of creating a final rollout. During intervening months, it is possible that new content becomes available while some content becomes unavailable due to contractual limitations on content use. For example, a contract may establish a contract window, which represents the time period that media content may be shown or distributed. A planned rollout indicates when the items can be distributed within the contract window. In step 320, a master planned rollout is created. The master planned rollout contains a list of items in the base rollout (i.e., a copy of the previous rollout), together with the new release titles available for the target-viewing period of the rollout being assembled.

As shown in FIG. 9, the master planned rollout is created by identifying the previous master planned rollout in step 321. If no prior master planned rollout exists, then step 321 may be omitted. In step 322, the system operator selects the planned rollout title, for example, from a pull-down menu from the system operator's display. In step 323, the system operator selects and enters target viewing dates into content management system 50. Target viewing dates are the dates that the rollout is available for viewing. In step 324, the master planned rollout report is generated. The report may indicate, for example, items that have not been through quality assurance, items that have passed quality assurance, contract violations (e.g., items that have a contract window that has ended before or during the planned rollout window or target view dates), and items already in a planned rollout that still contain valid contract dates. Each of these categories may be color-coded for easy recognition by the system operator.

As shown in FIG. 10, in step 330 a production rollout file is created. In step 331, the production rollout file is given a name or description. Thereafter, in step 332, a target size is selected and entered. The rollout target size is the number of hours of content programming to be included in the rollout. In step 333, an item target is selected. The item target defines the platform and encoding rate of the media assets and determines the naming convention of the filename of the media assets. The item target may be, for example, a high-bit rate Internet protocol (IP) platform, a low-bit rate IP platform, or a cable set top box client. In step 334, a graphic user interface showing various genres and sub-genres of content is selected. These genres and sub-genres may be dynamically determined and assigned to a given rollout. The genres and sub-genres are displayed in the graphical user interface presented to the consumer when the rollout becomes active. An example of a preferred graphic user interface is shown and described in U.S. application Ser. No. 09/054,752 titled “Graphic User Interface for a Digital Content Delivery System Using Circular Menus,” the disclosure of which is hereby incorporated by reference herein. In step 335, viewing dates are provided. It is preferred that the end view date should extend two weeks after the intended end view date of the rollout. This allows the rollout to continue to be used if a subsequent rollout is distributed late.

In FIG. 8, step 340 for creating a new production rollout is preferably accomplished in one of two ways. The new production rollout may be created by building an empty rollout and populating it, or more preferably by copying an existing rollout and editing it as previously described. Once the rollout has been created, a rollout console is preferably used to edit the rollout. The rollout console is a system user interface designed for easily and efficiently implementing rollout-editing decisions. It preferably allows the adding or removing of content, specifies a genre/sub-genre to which each item belongs, and sets the order in which the items appear in a sub-genre. In addition, the console provides access to the content preparation functionality that enables entry of advertisement demographics, creating items, entering metadata for the item, or performing quality assurance, if desired. Preferably, the console is divided into categories on the graphic user interface. Examples of some possible categories are as follows: advertisements, books, concerts, movies, music, shopping, television, radio, music shows, and a “suggest” category. The console preferably shows the total running time of all items selected thus far, the target running time of the rollout, a current item count, a media target, for example, a high-bit rate IP platform, and the graphic user interface being targeted. Also preferable is a listing of genres and sub-genres. The genre and sub-genre lists preferably share three columns, one column listing items having passed through quality assurance, another listing the number of items not having passed quality assurance, and a third column showing the total of time of viewing content thus far contained in each genre or sub-genre. The console preferably uses browser controls to navigate. Therefore, for example, selecting a particular sub-genre will open a window listing items currently available for inclusion in the rollout. In this way, items and any associated assets may be added or deleted from the rollout with greater ease. For example, a first run movie may exist as an incomplete item due to media assets that have not arrived in time to be encoded for inclusion in the rollout. The sub-genre screen would indicate this and the item might be removed from the rollout.

A rollout preferably has three statuses: “incomplete” (i.e., unpublishable in this state), “complete,” and “published.” A status of “incomplete” indicates that the rollout is being built. A status of “complete” indicates that programming for the rollout has been completed and prevents the rollout from being modified. This is a staging status prior to the rollout being published. A status of “published” indicates that the rollout has been published and is delivered to a storage location (e.g., a media server). Prior to publishing, a variety of reports are available for each rollout. For example, a rollout content report may be generated that lists the complete content of the rollout. A rollout add/delete report may be generated that compares a base rollout to a target rollout to produce a list of items that were added or deleted in the target rollout. This information is generated after creating a master content rollout. An “incomplete” assets report may be generated that provides a list of items for which there are incomplete media assets and identifies the missing media assets for each item. The “complete” assets report may be generated that provides a list of the items for which there are complete media assets and lists the media assets for each item. In addition to the four aforementioned reports, additional reports may be generated. For example, a new releases available report may be generated that includes items that have been created with a valid contract window covering the target viewing dates of the planned rollout. Additionally, an ad-hoc report may be generated. The ad-hoc report enables the system operator to search various attributes of the item, for example, contract dates or key words.

As shown in FIG. 11, the process of creating the production rollout preferably includes in step 341 selecting a desired rollout, preferably by a pull-down menu list from the system operator's display having rollout titles in combination with the rollout console. In step 342, the system operator adds any desired items. In step 343, the system operator deletes any undesired items. In step 344, the order of appearance of each item within a genre or sub-genre is determined. Thereafter, in step 345, quality assurance is performed. During the creation and/or management of a media asset and prior to going through quality assurance, the item may be designated as “inactive.” An “inactive” item will not be published in the rollout. Upon satisfactory completion of quality assurance procedure 345, content management system 50 may activate the item for inclusion in the rollout by changing its status from “inactive” to “active.” If all media assets are present, the metadata correct, and the video quality satisfactory, then the item passes quality assurance and is elevated to “active” status.

After building the rollout, the next step is to preferably publish the rollout. First, a “snapshot” is taken of the rollout. A “snapshot” is a copy of the rollout that locks in the programming except as indicated below. The snapshot includes the genre/sub-genre to which each item is assigned and the order in which each item is to be displayed. The snapshot also includes a view window for each item. Depending on the contractual start and end date for the item, the view window may or may not coincide with the rollout. The snapshot preferably only includes items that have an active status and valid view dates and have passed other business rule checks. Therefore, the published rollout may contain fewer items than the “pre-published” complete rollout. It is generally for this reason that both the before and after image of the rollout are retained with the before image being used when a rollout is copied. Next, the data included in the snapshot is made available to a distribution process to produce the physical elements of the rollout. Once the data has been moved, the data is no longer available for editing.

As will be appreciated by those skilled in the art, many of the steps used to create and publish the rollout may be applicable to the creation and publishing of packages through a package console having many of the same functions as the rollout console.

Other embodiments of the invention will be apparent to those skilled in the art from consideration of the specification and practice of the invention disclosed herein.

It is intended that the specification and examples be considered as exemplary only, with a true scope and spirit of the invention being indicated by the following

What is claimed is:

1. A method of preparing and managing media content access by consumers for a selected interval of time during which the content is offered to the consumers, the method comprising the steps of:
obtaining a media asset;
creating an item data structure;
associating the media asset with the item data structure;
associating metadata with the item data structure;
creating a first rollout data structure being operable for a selected interval of time;
selecting at least one item data structure to include in the first rollout data structure; and
storing the first rollout data structure at a storage location.

2. The method of claim 1, wherein said creating step includes configuring the first rollout data structure for a selected group of the consumers associated with the storage location.

3. The method of claim 1, wherein said selecting step is based on the viewing habits of the consumers.

4. The method of claim 1, wherein said selecting step is based on the demographics of the consumers.

5. The method of claim 1, further comprising the step of creating a second rollout data structure.

6. The method of claim 5, wherein said step of creating the second rollout data structure includes the sub-steps of copying the first rollout data structure and editing the copied rollout data structure.

7. The method of claim 5, further comprising the step of selecting item data structures for inclusion in the second rollout data structure so that the contents of the second rollout data structure is different from the contents of the first rollout data structure.

8. A method for creating and distributing a data structure for storing media content, the method comprising the steps of:
creating the data structure;
associating media content with the data structure based on selected criteria associated with a selected group of consumers; and
distributing the data structure to a storage location associated with the selected group of consumers.

9. The method of claim 8, further comprising the step of selecting an amount of time of media content programming to be included in the data structure.

10. The method of claim 8, further comprising the step of configuring the data structure to be accessible to the group of consumers for a selected interval of time.

11. The method of claim 8, wherein said distributing step includes the sub-step of distributing the data structure to the storage location accessible only by the selected group of consumers.

12. The method of claim 8, wherein said association step includes the sub-step of storing the media content in the data structure based on the demographics of the group of consumers.

13. The method of claim 8, wherein said association step includes the sub-step of storing the media content in the first rol lout data structure based on the viewing habits of the group of consumers.

14. The method of claim 8, wherein said association step includes the sub-step of storing the media content in the first rollout data structure based on the geographical location of the group of consumers.

15. A method for managing the access to media content, the method comprising the steps of:
obtaining a plurality of media assets;
associating with each media asset parameters related to the treatment of the media asset; and
offering the plurality of media assets to a group of consumers based on the parameters associated with each media asset.

16. The method of claim 15, wherein the parameters related to the treatment of the media asset include parameters related to the accessibility of the media asset to the group of consumers.

17. The method of claim 16, wherein the parameters related to the accessibility of the media asset to the group of consumers include a price of at least one of the media assets.

18. The method of claim 16, wherein the parameters related to the accessibility of the media asset to the group of consumers include a price range of at least one of the media assets.

19. The method of claim 16, wherein the parameters related to the accessibility of the media asset to the group of consumers include a contract window of at least one of the media assets during which the media asset is available for offering to the group of consumers.

20. The method of claim 16, wherein the parameters related to the accessibility of the media asset to the group of consumers include a parental control of at least one of the media assets for restricting access to a content rating.

21. The method of claim 15, wherein the parameters related to the treatment include parameters related to the distribution of the media asset to the group of consumers.

22. The method of claim 21, wherein the parameters related to the distribution of the media asset to the group of consumers include encryption of at least one of the media assets.

23. The method of claim 21, wherein the parameters related to the distribution of the media asset to the group of consumers include a bit rate requirement of each media asset.

24. The method of claim 21, wherein the parameters related to the distribution of the media asset to the group of consumers include a type of network useable for each media asset to be communicated through.

25. The method of claim 15, further comprising the step of associating an advertisement with at least one of the media assets.

26. The method of claim 15, further comprising the step of generating a report to indicate the availability of each media asset to be offered to the group of consumers.

27. A system for managing media content, the system comprising:
a memory for storing units of media content, the media content having different categories; and
a processor adapted to associate selected units of media content of different categories with at least one item data structure having a plurality of fields, each field adapted to correspond to any one of the different categories of media content.

28. The system of claim 27, wherein each unit of media content is associated with a unique identifier and each field is associated with a unique field identifier, said processor being adapted to associate the unique identifier of a unit of media content with the unique identifier of a field.

29. The system of claim 27, wherein each unit of media content is associated with a unique identifier and each item data structure is associated with a unique identifier, said processor being adapted to associate the unique identifier of a unit of media content with the unique identifier of an item data structure.

30. The system of claim 29, wherein said processor is adapted to include at least one selected item data structure in a package data structure based at least in part on the unique identifier of each selected item data structure, said package data structure being adapted to deliver each selected item data structure to a database accessible by consumers.

31. The system of claim 27, wherein the quantity of fields is determined based on a category of a media asset to be associated with the item data structure.

32. The system of claim 27, wherein at least one of said fields corresponds to a category of metadata.

33. A system for managing media content, the system comprising:
a processor adapted to associate selected item data structures with a rollout data structure for delivery to a database accessible by consumers, each selected item data structure having media content associated therewith, said rollout data structure being accessible by the consumers for a selected interval of time.

34. The system of claim 33, wherein said processor is adapted to associate each selected item data structure with the rollout data structure using a unique identifier associated with each of the selected item data structures.

35. The system of claim 33, wherein said rollout data structure is un-editable while being accessed by the consumers.

36. A method for associating media content with an item data structure, the method comprising the steps of:
providing an item data structure having a plurality of fields corresponding to any one of a plurality of different categories of media content, each field having a field identifier;
associating media content of a first category with a first one of the fields; and
associating media content of a different category with at least a second one of the fields.

37. The method of claim 36, further comprising the step of configuring the item data structure based on a category of at least one media asset to be associated with the item data structure.

38. The method of claim 37, wherein said configuring step includes determining the quantity and variety of fields to be included in the item data structure.

39. The method of claim 36, further comprising the step of assigning a unique identifier to the item data structure for tracking the item data structure.

40. The method of claim 39, further comprising the step of assigning a unique identifier to the media content, wherein each association step includes the sub-step of associating the media content identifier with the identifier of the item data structure.

41. The method of claim 39, further comprising the step of selecting at least one item data structure for association with a package data structure corresponding to at least one item data structure to a database accessible by consumers.

42. The method of claim 36, further comprising the step of assigning a unique identifier to the media content, wherein each field identifier is unique and each association step includes the sub-step of associating the media content identifier with the unique field identifier.

43. The method of claim 36, wherein said step of associating media content with the first one of the fields includes associating an advertisement with a field corresponding to an advertisement category.

44. The method of claim 43, further comprising the step of associating a link between the advertisement and an entity associated with a subject matter of the advertisement.

45. The method of claim 44, wherein said step of associating a link includes associating an Internet protocol link with the advertisement.

46. A data structure for multiple categories of media content, the data structure comprising:
a plurality of fields, at least a first one of said fields corresponding to any one of a plurality of different categories of media content, the category of media content corresponding to said first one of said fields being different from the category of media content corresponding to another one of said fields; and
a unique identifier associated with the data structure.

47. The data structure of claim 46, wherein at least one of said fields corresponds to a selected category of metadata.

48. The data structure of claim 46, wherein each field has a unique identifier and the media content has a unique identifier to facilitate association with the field identifier of the field corresponding to the category of the media content being associated therewith.

49. The data structure of claim 46, wherein the media content has a unique identifier to facilitate association with the unique identifier of the data structure.

50. The data structure of claim 46, wherein at least one of said fields corresponds to a category of media assets.

51. The data structure of claim 46, wherein the quantity and variety of fields present in the data structure are based on a selected category of at least one media asset to be associated with the data structure.

52. A method for creating an item data structure, the method comprising the steps of:
creating the item data structure having a number of undefined fields;
obtaining at least one media asset for association with the item data structure;
defining at least one of the fields based on a category of the at least one media asset to create at least one defined field;
associating an identifier with each defined field;
associating media content with each defined field; and
storing the item data structure in a database.

53. The method of claim 52, further comprising the step of selecting a category of media content for each defined field.

54. The method of claim 53, further comprising the step of selecting a category of metadata for at least one of the defined fields.

55. The method of claim 52, further comprising the step of associating a unique identifier with the item data structure for facilitating the organization of the item data structure in relation to other item data structures.
